(19) United States
(12) Patent Application Publication
(10) Pub. No.: US 2022/0230392 A1
(43) Pub. Date: Jul. 21, 2022

(54) SYSTEMS AND METHODS FOR IMPLEMENTING SOURCE IDENTIFIERS INTO 3D CONTENT

(71) Applicant: SEEK XR, INC., Lehi, UT (US)

(72) Inventor: Thane Brimhall, Saratoga Springs, UT (US)

(21) Appl. No.: 17/579,075

(22) Filed: Jan. 19, 2022

Related U.S. Application Data
(60) Provisional application No. 63/139,159, filed on Jan. 19, 2021.

(51) Int. Cl. G06T 17/20; G06T 17/30; G06T 15/04; H04L 9/08

(52) U.S. Cl. CPC G06T 17/20; H04L 9/0822; G06T 15/04; G06T 17/30

(57) ABSTRACT

A system configured for implementing source identifiers into 3D content is configurable to access one or more numbers defining one or more visual characteristics of a 3D model and modify digits of the one or more numbers to include an identifier code. The identifier code is associated with a particular source such that subsequent detection of the identifier code within the 3D model or a derivative 3D model derived from the 3D model indicates that the 3D model or the derivative 3D model originated from the particular source.

### CROSS-REFERENCE TO RELATED APPLICATIONS

This application claims priority to U.S. Provisional Patent Application Ser. No. 63/139,159, filed Jan. 19, 2021, and titled “SYSTEMS AND METHODS FOR IMPLEMENTING SOURCE IDENTIFIERS INTO 3D CONTENT”, the entirety of which is incorporated herein by this reference.

### BACKGROUND

Many content creators implement identifying images, patterns, designs, and/or other identifiers into their content for a variety of purposes, such as to indicate the source and/or authenticity of their content. In some instances, identifiers are implemented subtly so as to be non-obvious during casual inspection, while in other instances, identifiers are implemented so as to be obvious during casual inspection. In some instances, non-obvious identifiers are useful when determining whether content was copied from another source. For example, where an individual copies content that includes a non-obvious identifier and presents the content as being originally created by the individual, showing that the content putatively created by the individual includes the non-obvious identifier indicates that the individual is not the original creator of the content and that the individual derived the content from an original creator (e.g., the creator that placed the non-obvious identifier).

Non-obvious identifiers have been implemented into two-dimensional (2D) graphics and even into physical products. However, implementing non-obvious identifiers into 3-dimensional (3D) models is associated with many challenges. For example, initially generating identifiers for 3D models that are not obvious upon casual inspection is difficult because 3D models may be used for myriad purposes (e.g., video games, movies, architecture, illustration, engineering, advertising, extended reality experiences, etc.) and may be presented/viewed in numerous contexts (e.g., from different angles and/or viewing distances, under different lighting or other ambient conditions, etc.). Furthermore, 3D models may include multiple portions or components with different visual characteristics, thereby increasing the difficulty of creating non-obvious identifiers that can be implemented to complement different visual characteristics of different portions of a 3D model. Failing to implement a non-obvious identifier into significant portions of 3D content may allow individuals to selectively copy portions of the 3D content that omit a non-obvious identifier and thereby avoid detection.

Accordingly, there exists a need for improved systems and methods for implementing source identifiers into 3D content.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments of the present disclosure are directed to systems and methods for implementing source identifiers into 3D content.

In at least one aspect, a system configured for implementing source identifiers into 3D content is configurable to access one or more numbers defining one or more visual characteristics of a 3D model and modify digits of the one or more numbers to include an identifier code. In some instances, the one or more numbers define an attribute of one or more vertices of the 3D model, such as a vertex position, normal vector, tangent vector, and/or other vertex attribute. In some instances, the one or more numbers define texture map coordinates for the 3D model.

In some instances, the modified digits are offset from respective decimal separators of the one or more numbers by a predefined number of decimal places. Furthermore, in some instances, the modified digits describe distances or positions that meet or exceed a threshold level of measurement precision represented by the one or more numbers. In one example, the threshold level of measurement precision is tenths of millimeters.

The identifier code may comprise any combination of numbers. In some instances, the identifier code comprises a cryptographic key.

In at least one aspect, a system configured for detecting source identifiers in 3D content is configurable to access one or more numbers defining one or more visual characteristics of a 3D model and determine whether an identifier code is present based on particular digits of the one or more numbers defining the one or more visual characteristics of the 3D model. In response to determining that the identifier code is present based on the particular digits of the one or more numbers defining the one or more visual characteristics of the 3D model, the system is configurable to generate output indicating that the 3D model originated from a source associated with the identifier code.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

Additional features and advantages of the disclosure will be set forth in the description which follows, and in part will be obvious from the description, or may be learned by the practice of the disclosure. The features and advantages of the disclosure may be realized and obtained by means of the instruments and combinations particularly pointed out in the appended claims. These and other features of the present disclosure will become more fully apparent from the following description and appended claims or may be learned by the practice of the disclosure as set forth hereinafter.

### BRIEF DESCRIPTION OF THE DRAWINGS

In order to describe the manner in which the above recited and other advantages and features of the disclosure can be obtained, a more particular description of the disclosure briefly described above will be rendered by reference to specific embodiments thereof, which are illustrated in the appended drawings. It is appreciated that these drawings depict only typical embodiments of the disclosure and are not therefore to be considered to be limiting of its scope.

The disclosure will be described and explained with additional specificity and detail through the use of the accompanying drawings in which:

FIG. 1A illustrates a conceptual representation of numbers associated with vertex attributes of vertices of 3D content;

FIG. 1B illustrates a conceptual representation of modified numbers associated with the vertex attributes of the vertices of the 3D content from FIG. 1A;

FIG. 2 illustrates an example flow diagram depicting acts associated with implementing source identifiers into 3D content;

FIG. 3 illustrates an example flow diagram depicting acts associated with detecting source identifiers in 3D content, in accordance with the present disclosure; and

FIG. 4 illustrates example components of a system that may comprise or be configured to implement one or more disclosed embodiments.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed invention. In addition, any headings used herein are for organizational purposes only, and the terminology used herein is for the purpose of describing the embodiments. Neither are not meant to be used to limit the scope of the description or the claims.

Embodiments of the present disclosure are directed to systems and methods for implementing source identifiers into 3D content. In some instances, facilitating the implementation of source identifiers into 3D content includes accessing one or more numbers defining one or more visual characteristics of a 3D model and modifying digits of the one or more numbers to include an identifier code. In some instances, the one or more numbers define an attribute of one or more vertices of the 3D model, such as a vertex position, normal vector, tangent vector, and/or other vertex attribute. In some instances, the one or more numbers define texture map coordinates for the 3D model.

In some instances, the modified digits are offset from respective decimal separators of the one or more numbers by a predefined number of decimal places. Furthermore, in some instances, the modified digits describe distances or positions that meet or exceed a threshold level of measurement precision represented by the one or more numbers. In one example, the threshold level of measurement precision is tenths of millimeters.

The identifier code may comprise any combination of numbers. In some instances, the identifier code comprises a cryptographic key.

Those skilled in the art will appreciate, in view of the present disclosure, that at least some of the disclosed embodiments may facilitate implementation of source identifiers into 3D content in an advantageous manner. For instance, the digits of the numbers associated with the 3D content that become modified may be selected such that modifications made thereto have a substantially imperceptible effect on the rendering of the 3D content. For example, for numbers defining the positional coordinates of a vertex of 3D content, the digits that become encoded with the identifier code may be at place values associated with high measurement precision (e.g., the tenths of millimeters or finer precision), such that the modifications made to the digits only imperceptibly affect the appearance of the 3D content.

In this regard, source identifiers of the present disclosure may be implemented into several or all parts of a 3D creation (e.g., a 3D model) and remain substantially imperceptible to users, even where different parts of the 3D creation include different visual characteristics or themes.

Implementing source identifiers into original 3D content as described herein may allow users to determine whether subsequent works are derived from the original 3D content, whether in whole or in part. For example, as indicated herein, identifier code may be implemented into numbers that define/describe several or all parts of the original 3D content. Thus, when a subsequent user copies the original 3D content to create a subsequent work, whether in whole or in part, the subsequent user will also copy the numbers that define/describe the original 3D content. Thus, the identifier code will be present in the subsequent work, and copying from the original 3D content may be shown by detecting the identifier code within the values or numbers that define the subsequent work.

In some instances, a subsequent user creates a subsequent work by copying original 3D content and making modifications thereto in an attempt to conceal their derivation from the original 3D content. Such modifications may include translating, rotating, rescaling, or otherwise modifying the vertices of copied 3D content. However, the source identifiers of the present disclosure may be robust against such modifications and may still facilitate detection of copying where such modifications are performed.

For example, identifier code embedded into the values that define 3D content may create unique relationships between different portions of the 3D content, and such unique relationships may also serve as source identifiers. For instance, where positional information for multiple vertices of original 3D content are encoded with identifier code, the particular relative positions of the multiple vertices (e.g., after encoding) may serve as a source identifier and may be detected in subsequent works that copy the 3D content, even where the absolute positions of the multiple vertices are modified by a common operation. Thus, the unique positional relationships between the vertices would persist and be observable in subsequent works that include copies of one or more portions of the original 3D content, even where such portions of the original 3D content are commonly translated or otherwise modified to form a subsequent work.

The unique relationships between different values that define 3D content may be represented in any suitable way to account for different types of modifications that may be made to the 3D content when copying the 3D content to form subsequent works, such as distance between values, ratios of values, ratios of distances between values, and/or others. Accordingly, implementations of the present disclosure may facilitate implementing source identifiers into 3D content in a manner that is imperceptible to lay users and yet robust against conventional techniques for obfuscating the copying of 3D content.

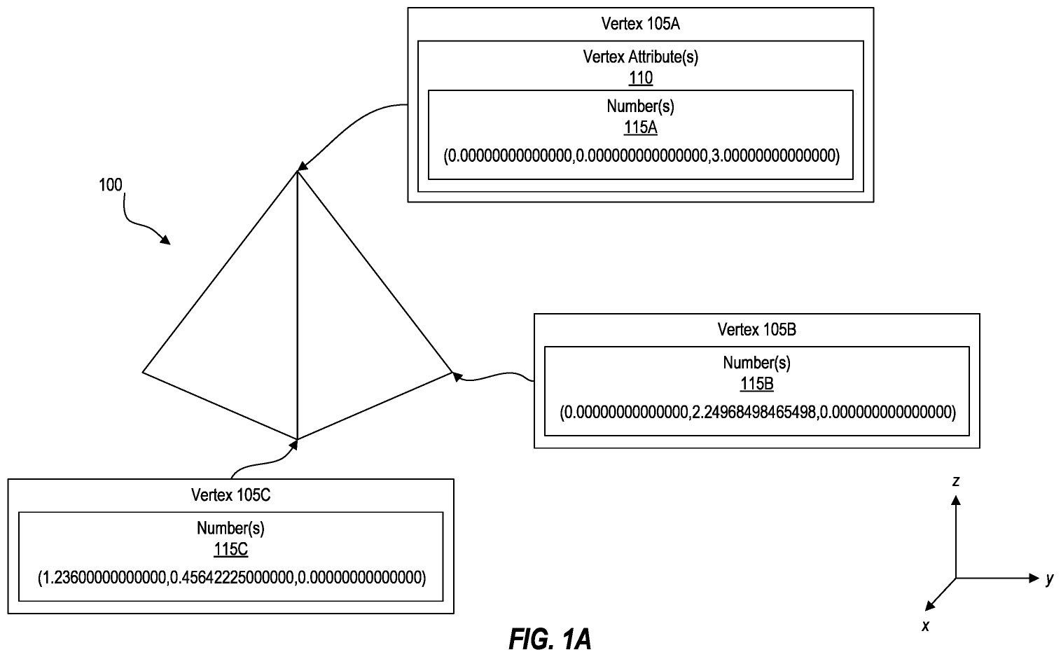

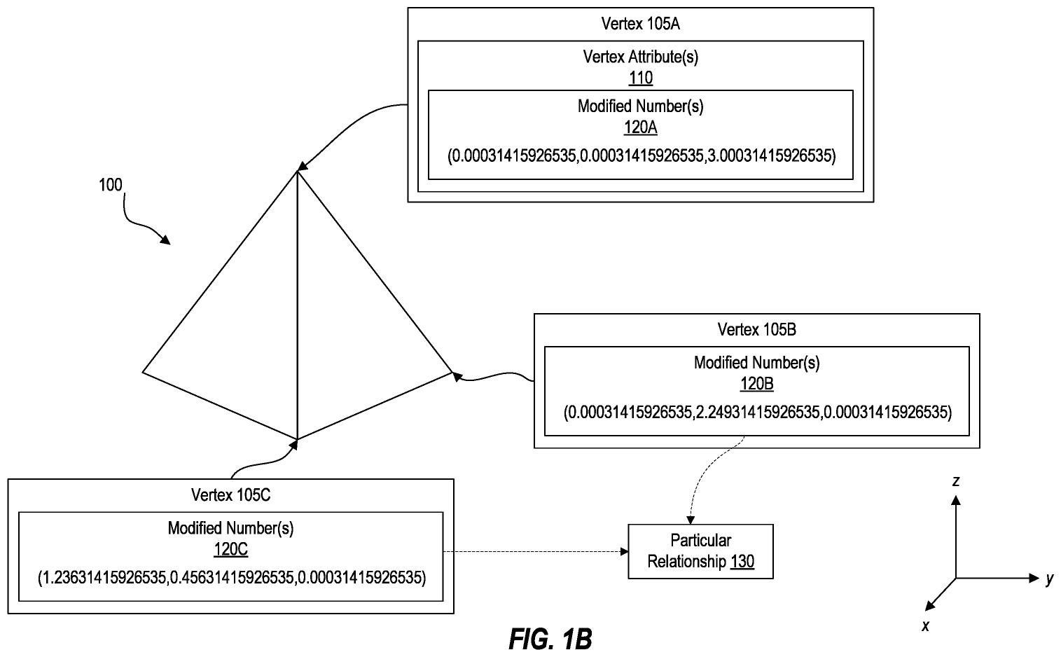

Having described some of the various high-level features and benefits of the disclosed embodiments, attention will now be directed to FIGS. 1A through 4. These FIGS. illustrate various conceptual representations, architectures, methods, and/or supporting illustrations related to the disclosed embodiments.

### Example Techniques for Implementing and Detecting Source Identifiers in 3D Content

FIG. 1A illustrates a conceptual representation of numbers associated with vertex attributes of vertices of 3D content. In particular, FIG. 1A illustrates 3D content in the form of a 3D model 100 of a pyramid. The 3D model 100 of FIG. 1A comprises a wireframe model including a mesh formed from multiple vertices and may include textures applied to the mesh. Although the present disclosure focuses, in at least some respects, on implementing source identifiers into wireframe 3D content, at least some of the principles described herein may be applied to other types of 3D content, such as primitive models, polygonal models, rational B-spline models, non-uniform rational basis spline models, computer-aided design models, solid models, surface models, and/or others.

As indicated above, the 3D model 100 of FIG. 1A includes a plurality of vertices, including vertex 105A, vertex 105B, and vertex 105C. The vertices of the 3D model 100 may be associated with various types of vertex attributes 110 and may include information for defining the 3D model 100. For example, vertex attributes 110 may comprise spatial position information (e.g., spatial coordinates) for defining the absolute or relative positions of the various vertices. The vertices of the 3D model may be used to define the surfaces of the 3D model 100, forming the shape thereof. For example, vertices 105A, 105B, and 105C are positioned such that connecting the vertices via lines forms a polygon (e.g., a triangle) that provides a surface of the 3D model 100. Other vertices of the 3D model 100 may be used to form a polygon surface mesh for the 3D model 100, and textures may be applied to the polygon mesh (e.g., via a texture coordinate map or UV map) to complete the 3D model 100.

FIG. 1A shows that numbers may be used to define vertex attributes 110 of the various vertices of the 3D model 100. For example, as illustrated in FIG. 1A, number 115A provides spatial coordinates in (x, y, z) format defining a vertex position of the vertex 105A of the 3D model 100 at (0.00000000000000,0.00000000000000,3.00000000000000), indicating that the vertex 105A is positioned along a z-axis at a distance of 3.00000000000000 units from an x-y plane. Similarly, number 115B defines a vertex position of the vertex 105B of the 3D model 100 at (0.00000000000000,2.24968498465498,0.00000000000000), indicating that the vertex 105B is positioned along a y-axis at a distance of 2.24968498465498 units from an x-z plane. Furthermore, number 115C defines a vertex position of the vertex 105C of the 3D model 100 at (1.23600000000000,0.45642225000000,0.00000000000000).

Numbers defining vertex attribute(s) 110 of a 3D model 100 may be associated with real-world position metrics (e.g., meters, millimeters, fractions of millimeters, etc.) or may be unitless. Furthermore, although FIG. 1A illustrates the numbers 115A, 115B, and 115C with a particular level of precision or number of significant FIGS. or decimal places/place values, the particular configuration(s) shown in FIG. 1A are provided by way of example only and are not limiting of the present disclosure. For example, a number defining a vertex attribute of a 3D model may omit a decimal or may include a decimal that is not placed or represented among significant digits of the number. In addition, it will be appreciated, in view of the present disclosure, that numbers defining vertex attribute(s) 110 of a 3D model 100 may be represented according to any suitable data type, such as an integer, floating-point number, floating-point expansion, logarithmic number system representation, fixed-point number, and/or others.

As will be described in more detail with reference to FIG. 1B, digits of the numbers (e.g., including numbers 115A, 115B, and/or 115C) defining vertex attributes of a 3D model 100 may be modified or encoded with identifier code to provide a source identifier for the 3D model 100. For example, a computer system may be configured to access numbers defining visual characteristics of a 3D model and modify digits of the numbers to include an identifier code, which may be operable to facilitate the detection of copying of the 3D model into subsequent works, as described hereinabove.

FIG. 1B illustrates a conceptual representation of modified numbers associated with the vertex attributes of the vertices of the 3D content from FIG. 1A. In particular, FIG. 1B shows that the numbers 115A, 115B, and 115C of FIG. 1A defining vertex attribute(s) 110 of the vertices 105A, 105B, and 105C of the 3D model 100, respectively, are modified to include an identifier code. For example, modified number 120A defines a modified vertex position of the vertex 105A of the 3D model 100 (relative to the position defined by number 115A) at (0.00031415926535,0.00031415926535,3.00031415926535). Similarly modified number 120B defines a modified vertex position of the vertex 105B of the 3D model 100 (relative to the number 115B) at (0.00031415926535,2.24931415926535,0.00031415926535), and modified number 120C defines a modified vertex position of the vertex 105C (relative to the number 115C) at (1.23631415926535,0.45631415926535,0.00031415926535).

As is evident from the examples shown in FIGS. 1A and 1B, the modified numbers 120A, 120B, and 120C of FIG. 1B are different than the numbers 115A, 115B, and 115C of FIG. 1A in that each of the directional components of the modified numbers 120A, 120B, and 120C includes the digits “31415926535” (e.g., the first ten digits of π) implemented into the ten thousandths and subsequent decimal places. The digits “31415926535” of the modified numbers 120A, 120B, and 120C may operate as an identifier code for the 3D model 100 and may function as a source identifier for the 3D model 100 (e.g., to detect copying of the 3D model 100).

For example, if the 3D model 100 is published or made otherwise available to the public using the modified numbers (e.g., including modified numbers 120A, 120B, and 120C) that include the identifier code “31415926535” to define the 3D model 100, subsequent users who copy portions of the 3D model 100 or the entire 3D model 100 will also copy the modified numbers that include the identifier code “31415926535” into their subsequent works. Accordingly, if a subsequent user publishes a subsequent work that includes the copied 3D model 100 or portions thereof, the subsequent work may be inspected to detect the presence of the identifier code “31415926535” among the numbers defining the subsequent work (e.g., numbers defining vertex positions of the subsequent work). The presence of the identifier code “31415926535” among the numbers defining the subsequent work may indicate that the subsequent work was at least partially copied from the 3D model.

In some instances, subsequent users will copy one or more portions of the 3D model 100 and translate or move the vertices thereof in an attempt to conceal their copying before publishing a subsequent work. Such modifications may modify the numbers associated with the vertices that define the subsequent work and therefore modify the identifier code “31415926535” that would otherwise be present in the subsequent work. However, as noted above, implementing one or more identifier codes into the 3D model 100 creates, in some instances, unique relationships between the modified numbers associated with the various vertices of the 3D model 100. Such unique relationships (or values based thereon) may still be detected in subsequent works even after subsequent users modify a copy of the 3D model 100.

For example, in some instances, defining the 3D model 100 using the modified number 120B for the spatial position of the vertex 105B and using the modified number 120C for the spatial position of the vertex 105C creates a particular relationship 130 between the vertex 105B and the vertex 105C (as depicted in FIG. 1B by the dashed arrows extending from the modified number 120B and the modified number 120C toward the particular relationship 130). An example particular relationship 130 may comprise a particular absolute or Euclidean distance between the vertex 105B and the vertex 105C. In the example shown, the particular Euclidean distance between vertex 105B and vertex 105C is 2.17773850588173, which may be used as a component of a source identifier for the 3D model 100. A Euclidean distance between vertices of a subsequent work that correspond to vertex 105B and vertex 105C of the 3D model 100 may be measured. Such measurements may be performed as between positional coordinates for multiple vertices of the subsequent work that appear to correspond to vertices of the 3D model 100, and matching Euclidean distance measurements may indicate that the subsequent work was at least partially copied from the 3D model 100.

As another example of a particular relationship 130, in some instances, implementing one or more identifier codes into the modified numbers 120B and 120C associated, respectively, with vertex 105B and vertex 105C creates a particular numerical relationship between the modified numbers 120B and 120C. For instance, the numerical relationship may be represented as a ratio, such as a ratio between one or more components of the modified numbers 120B and 120C. In the example shown, such a ratio between the y components of the modified numbers 120B and 120C is 2.24931415926535/0.45631415926535=4.92931046208749. Such a ratio of y components between vertices in a subsequent work that correspond to vertex 105B and vertex 105C of the 3D model may be determined. Such ratios may be determined as between numbers associated with multiple vertices of the subsequent work that appear to correspond to vertices of the 3D model 100, and matching ratios may indicate that the subsequent work was at least partially copied from the 3D model 100.

The relationships (e.g., particular relationship 130) between the modified numbers (e.g., modified numbers 120A, 120B, and 120C) of a 3D model 100 may thus operate as identifier codes. Furthermore, such relationships may be used to determine other unique relationships that may additionally or alternatively be used to detect copying in subsequent works, in accordance with the present disclosure. Such unique relationships may be operable to detect copying even where modifications such as translation, rotation, and/or rescaling are performed on the copied content. In some instances, numbers associated with vertices of a putatively copied work may be directly compared to numbers associated with vertices of an original work (that include source identifiers) to detect copying using computer-driven mathematical solvers.

Although the identifier code in the example depicted in FIG. 1B comprises the first 10 digits of π, one will appreciate, in view of the present disclosure, that an identifier code may comprise any arrangement of numbers. For example, in some implementation, an identifier code may comprise a cryptographic key, such as a Rivest-Shamir-Adleman (RSA) public key or another type of cryptographic key.

Furthermore, although the present disclosure focuses, in at least some respects, on an example in which all coordinate values (e.g., x, y, and z coordinate values) defining the positions of vertices become encoded with an identifier code, it will be appreciated, in view of the present disclosure, that any number of values defining a vertex attribute may be encoded with an identifier code or be selectively not encoded with an identifier code. By way of non-limiting example, in some implementations, only the x coordinate becomes encoded with an identifier code, or different coordinate values (or different numbers defining different attributes of the 3D model) become encoded with different identifier codes.

As noted above, the particular decimal configurations of the numbers and/or modified numbers shown and described with reference to FIGS. 1A and 1B are illustrative only and non-limiting. Furthermore, although the examples shown and described with reference to FIGS. 1A and 1B focus, in at least some respects, on modifying digits within the ten thousandths and subsequent decimal places to encode numbers with identifier codes, consecutive (or non-consecutive) digits of any place values may be modified to include an identifier code. In some implementations, the modified digits are offset from a decimal separator by a predefined number of decimal places (e.g., the tens place and the subsequent 11 place values).

Furthermore, in some instances, the digits that become modified are digits that describe distances or positions that meet or exceed a threshold level of measurement precision, regardless of whether or a decimal separator is implemented. For instance, in some implementations, the modified digits are digits that describe distances (or positions, or other metrics) in tenths of millimeters or smaller units. In some configurations, modifying such digits to implement identifier codes may advantageously prevent the identifier codes from perceptibly affecting the presentation of the 3D model.

Although the present disclosure focuses, in at least some respects, on modifying numbers defining the spatial coordinate values of vertices to implement identifier codes, it should be noted that other vertex attributes may be modified to implement identifier codes in accordance with the present disclosure. For example, normal vectors and/or tangent vectors associated with vertices may be modified to implement identifier codes.

Additionally, or alternatively, other numbers associated with defining visual aspects of a 3D model may be modified to implement identifier codes in accordance with the present disclosure, such as numbers defining texture map coordinates of a 3D model or numbers defining color, reflectance, blend weight/shape, and/or other aspects of a 3D model.

### Example Method(s) for Implementing and Detecting Source Identifiers in 3D Content

The following discussion now refers to a number of methods and method acts that may be performed in accordance with the present disclosure. Although the method acts are discussed in a certain order and illustrated in a flow chart as occurring in a particular order, no particular ordering is required unless specifically stated, or required because an act is dependent on another act being completed prior to the act being performed. One will appreciate that certain embodiments of the present disclosure may omit one or more of the acts described herein.

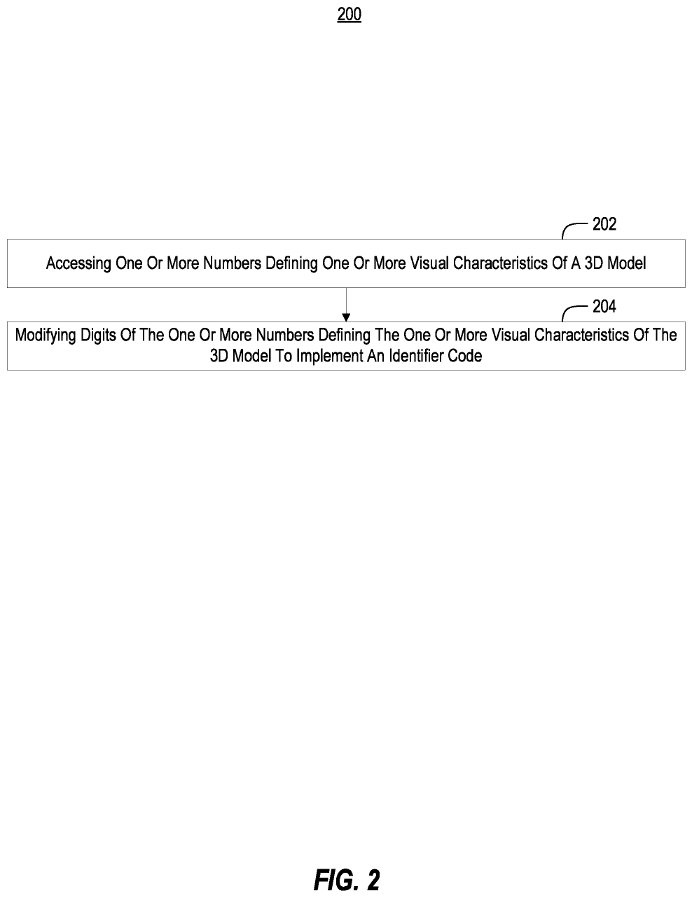

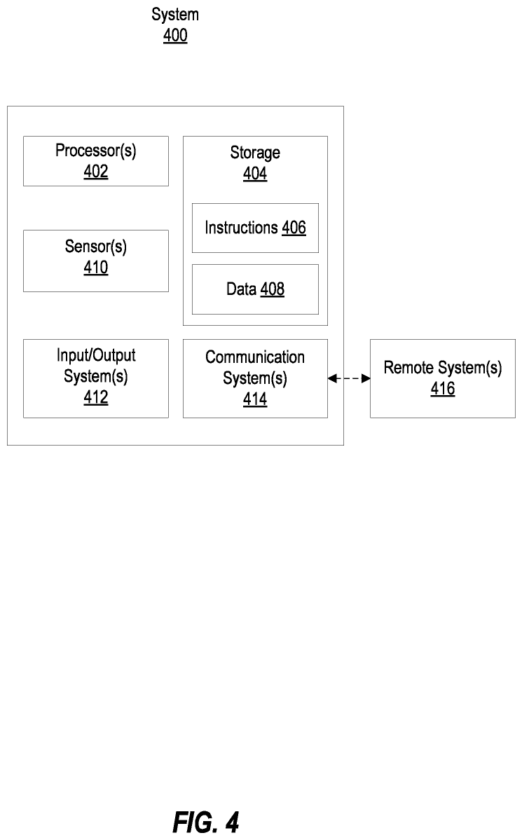

FIG. 2 illustrates an example flow diagram 200 depicting acts associated with implementing source identifiers into 3D content. The various acts of flow diagram 200 discussed herein may be performed utilizing one or more components of one or more systems (e.g., processors 402, storage 404, sensor(s) 410, input/output system(s) 412, communication system(s) 416, etc., as discussed in more detail hereinafter with reference to FIG. 4).

Act 202 of flow diagram 200 includes accessing one or more numbers defining one or more visual characteristics of a 3D model. In some implementations, the one or more numbers define an attribute (e.g., vertex attribute(s) 110 of FIGS. 1A) of one or more vertices of the 3D model (e.g., vertices 105A, 105B, and 105C of FIGS. 1A). For instance, the attribute defined by the one or more numbers may comprise a vertex position (e.g., numbers 115A, 115B, and 115C of FIG. 1A), normal vector, tangent vector, and/or others. In some instances, the one or more numbers define texture map coordinates for the 3D model.

Act 204 of flow diagram 200 includes modifying digits of the one or more numbers defining the one or more visual characteristics of the 3D model to implement an identifier code. The identifier code may be associated with a particular source such that subsequent detection of the identifier code within the 3D model (or a derivative 3D model derived from the 3D model) indicates that the 3D model (or the derivative 3D model) originated from the particular source.

In some instances, the digits of the one or more numbers that become modified are offset from respective decimal separators of the one or more numbers by a predefined number of decimal places. In some implementations, the modified digits describe attributes (e.g., distances or positions) with a level of measurement precision that meets or exceeds a threshold level of measurement precision (e.g., tenths of millimeters).

The identifier code implemented into the digits of the one or more numbers may take on various forms, such as a predefined numerical code or value, a cryptographic key, and/or others. In some implementations, digits of a plurality of numbers that define one or more visual characteristics of the 3D model become modified in accordance with act 204, and the modification of the digits implements one or more particular relationships (e.g., particular relationship 130 of FIG. 1B) among the plurality of numbers. In such cases, the one or more particular relationships may form the identifier code.

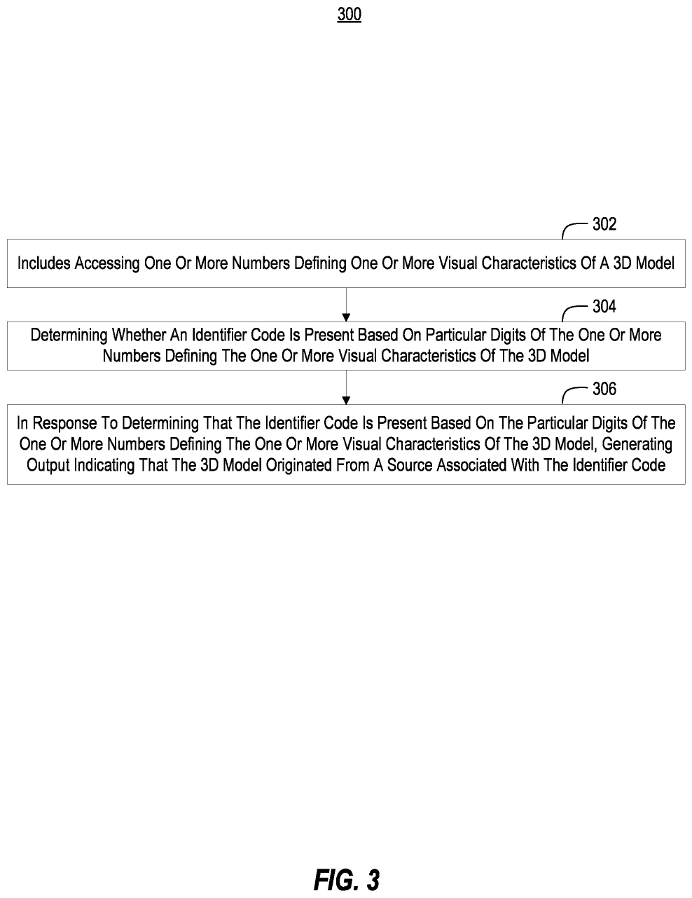

FIG. 3 illustrates an example flow diagram 300 depicting acts associated with detecting source identifiers in 3D content. The various acts of flow diagram 300 discussed herein may be performed utilizing one or more components of one or more systems (e.g., processors 402, storage 404, sensor(s) 410, input/output system(s) 412, communication system(s) 416, etc., as discussed in more detail hereinafter with reference to FIG. 4).

Act 302 of flow diagram 300 includes accessing one or more numbers defining one or more visual characteristics of a 3D model. In some implementations, the one or more numbers define an attribute (e.g., vertex attribute(s) 110 of FIGS. 1A) of one or more vertices of the 3D model (e.g., vertices 105A, 105B, and 105C of FIGS. 1A). For instance, the attribute defined by the one or more numbers may comprise a vertex position (e.g., numbers 115A, 115B, and 115C of FIG. 1A), normal vector, tangent vector, and/or others. In some instances, the one or more numbers define texture map coordinates for the 3D model.

Act 304 of flow diagram 300 includes determining whether an identifier code is present based on particular digits of the one or more numbers defining the one or more visual characteristics of the 3D model. In some instances, the particular digits are offset from respective decimal separators of the one or more numbers by a predefined number of decimal places. In some instances, the particular digits describe distances or positions that meet or exceed a threshold level of measurement precision represented by the one or more numbers (e.g., tenths of millimeters).

In some instances, particular digits of a plurality of numbers that define one or more visual characteristics of the 3D model are used to determine whether the identifier code is present. The particular digits of the plurality of numbers may impose a particular relationship among the plurality of numbers. In some instances, detection of the particular relationship may indicate that the identifier code is present (stated differently, the identifier code may comprise the particular relationship).

Act 306 of flow diagram 300 includes, in response to determining that the identifier code is present based on the particular digits of the one or more numbers defining the one or more visual characteristics of the 3D model, generating output indicating that the 3D model originated from a source associated with the identifier code. Such output may take on various forms, such as triggering display of one or more user interface elements that indicate that the 3D model originated from the source associated with the identifier code. In some implementations, the output may comprise sending a notification or communication to a particular entity, or storing or logging information associated with the 3D model (e.g., publishing entity, URL, publication date, etc.) within a data structure, document, file, etc.

### Additional Details Related to Implementing the Disclosed Embodiments

The principles disclosed herein may be implemented in various formats. For example, the various techniques discussed herein may be performed as a method that includes various acts for achieving particular results or benefits. In some instances, the techniques discussed herein are represented in computer-executable instructions that may be stored on one or more hardware storage devices. The computer-executable instructions may be executable by one or more processors to carry out (or to configure a system to carry out) the disclosed techniques. In some embodiments, a system may be configured to send the computer-executable instructions to a remote device to configure the remote device for carrying out the disclosed techniques.

FIG. 4 illustrates various example components of a system 400 that may be used to implement one or more disclosed embodiments. For example, FIG. 4 illustrates that a system 400 may include processor(s) 402, storage 404, sensor(s) 410, input/output system(s) 412 (I/O system(s) 412), and communication system(s) 414. Although FIG. 4 illustrates a system 400 as including particular components, one will appreciate, in view of the present disclosure, that a system 400 may comprise any number of additional or alternative components.

The processor(s) 402 may comprise one or more sets of electronic circuitries that include any number of logic units, registers, and/or control units to facilitate the execution of computer-readable instructions (e.g., instructions that form a computer program). Such computer-readable instructions may be stored within storage 404. The storage 404 may comprise physical system memory and may be volatile, non-volatile, or some combination thereof. Furthermore, storage 404 may comprise local storage, remote storage (e.g., accessible via communication system(s) 414 or otherwise), or some combination thereof. Additional details related to processors (e.g., processor(s) 402) and computer storage media (e.g., storage 404) will be provided hereinafter.

In some implementations, the processor(s) 402 may comprise or be configurable to execute any combination of software and/or hardware components that are operable to facilitate processing using machine learning models or other artificial intelligence-based structures/architectures. For example, processor(s) 402 may comprise and/or utilize hardware components or computer-executable instructions operable to carry out function blocks and/or processing layers configured in the form of, by way of non-limiting example, single-layer neural networks, feed forward neural networks, radial basis function networks, deep feed-forward networks, recurrent neural networks, long-short term memory (LSTM) networks, gated recurrent units, autoencoder neural networks, variational autoencoders, denoising autoencoders, sparse autoencoders, Markov chains, Hopfield neural networks, Boltzmann machine networks, restricted Boltzmann machine networks, deep belief networks, deep convolutional networks (or convolutional neural networks), deconvolutional neural networks, deep convolutional inverse graphics networks, generative adversarial networks, liquid state machines, extreme learning machines, echo state networks, deep residual networks, Kohonen networks, support vector machines, neural Turing machines, and/or others.

As will be described in more detail, the processor(s) 402 may be configured to execute instructions 406 stored within storage 404 to perform certain actions. The actions may rely at least in part on data 408 stored on storage 404 in a volatile or non-volatile manner.

In some instances, the actions may rely at least in part on communication system(s) 414 for receiving data from remote system(s) 416, which may include, for example, separate systems or computing devices, sensors, and/or others. The communications system(s) 414 may comprise any combination of software or hardware components that are operable to facilitate communication between on-system components/devices and/or with off-system components/devices. For example, the communications system(s) 414 may comprise ports, buses, or other physical connection apparatuses for communicating with other devices/components. Additionally, or alternatively, the communications system(s) 414 may comprise systems/components operable to communicate wirelessly with external systems and/or devices through any suitable communication channel(s), such as, by way of non-limiting example, Bluetooth, ultra-wideband, WLAN, infrared communication, and/or others.

FIG. 4 illustrates that a system 400 may comprise or be in communication with sensor(s) 410. Sensor(s) 410 may comprise any device for capturing or measuring data representative of perceivable or detectable phenomenon. By way of non-limiting example, the sensor(s) 410 may comprise one or more image sensors, microphones, thermometers, barometers, magnetometers, accelerometers, gyroscopes, and/or others.

Furthermore, FIG. 4 illustrates that a system 400 may comprise or be in communication with I/O system(s) 412. I/O system(s) 412 may include any type of input or output device such as, by way of non-limiting example, a touch screen, a mouse, a keyboard, a controller, and/or others, without limitation. For example, the I/O system(s) 412 may include a display system that may comprise any number of display panels, optics, laser scanning display assemblies, and/or other components.

The system 400 may comprise or utilize various types of devices, such as one or more server(s), cloud resources, personal computing device, mobile electronic devices, and/or other devices.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Computer-readable media that merely carry computer-executable instructions without storing the computer-executable instructions are “transmission media.” Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Disclosed embodiments may comprise or utilize cloud computing. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, wearable devices, and the like. The invention may also be practiced in distributed system environments where multiple computer systems (e.g., local and remote systems), which are linked through a network (either by hardwired data links, wireless data links, or by a combination of hardwired and wireless data links), perform tasks. In a distributed system environment, program modules may be located in local and/or remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

As used herein, the terms “executable module,” “executable component,” “component,” “module,” or “engine” can refer to hardware processing units or to software objects, routines, or methods that may be executed on one or more computer systems. The different components, modules, engines, and services described herein may be implemented as objects or processors that execute on one or more computer systems (e.g. as separate threads).

One will also appreciate how any feature or operation disclosed herein may be combined with any one or combination of the other features and operations disclosed herein. Additionally, the content or feature in any one of the FIGS. may be combined or used in connection with any content or feature used in any of the other figures. In this regard, the content disclosed in any one FIG. is not mutually exclusive and instead may be combinable with the content from any of the other figures.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system configured for implementing source identifiers into 3D content, comprising:
one or more processors; and
one or more hardware storage devices storing instructions that are executable by the one or more processors to configure the system to:
access one or more numbers defining one or more visual characteristics of a 3D model; and
modify digits of the one or more numbers defining the one or more visual characteristics of the 3D model to implement an identifier code, the identifier code being associated with a particular source such that subsequent detection of the identifier code within the 3D model or a derivative 3D model derived from the 3D model indicates that the 3D model or the derivative 3D model originated from the particular source.

2. The system of claim 1, wherein the one or more numbers define an attribute of one or more vertices of the 3D model.

3. The system of claim 2, wherein the attribute comprises a vertex position.

4. The system of claim 2, wherein the attribute comprises a normal vector or a tangent vector.

5. The system of claim 1, wherein the one or more numbers define texture map coordinates for the 3D model.

6. The system of claim 1, wherein the modified digits are offset from respective decimal separators of the one or more numbers by a predefined number of decimal places.

7. The system of claim 1, wherein the modified digits describe distances or positions that meet or exceed a threshold level of measurement precision represented by the one or more numbers.

8. The system of claim 7, wherein the threshold level of measurement precision is tenths of millimeters.

9. The system of claim 1, wherein the identifier code comprises a cryptographic key.

10. The system of claim 1, wherein the one or more numbers comprises a plurality of numbers, and wherein modifying the digits of the plurality of numbers defining the one or more visual characteristics of the 3D model implements a particular relationship among the plurality of numbers, and wherein the identifier code comprises the particular relationship.

11. A system configured for detecting source identifiers in 3D content, comprising:
one or more processors; and
one or more hardware storage devices storing instructions that are executable by the one or more processors to configure the system to:
access one or more numbers defining one or more visual characteristics of a 3D model;
determine whether an identifier code is present based on particular digits of the one or more numbers defining the one or more visual characteristics of the 3D model; and
in response to determining that the identifier code is present based on the particular digits of the one or more numbers defining the one or more visual characteristics of the 3D model, generate output indicating that the 3D model originated from a source associated with the identifier code.

12. The system of claim 11, wherein the one or more numbers define an attribute of one or more vertices of the 3D model.

13. The system of claim 12, wherein the attribute comprises a vertex position.

14. The system of claim 12, wherein the attribute comprises a normal vector or a tangent vector.

15. The system of claim 11, wherein the one or more numbers define texture map coordinates for the 3D model.

16. The system of claim 11, wherein the particular digits are offset from respective decimal separators of the one or more numbers by a predefined number of decimal places.

17. The system of claim 11, wherein the particular digits describe distances or positions that meet or exceed a threshold level of measurement precision represented by the one or more numbers.

18. The system of claim 17, wherein the threshold level of measurement precision is tenths of millimeters.

19. The system of claim 11, wherein the one or more numbers comprises a plurality of numbers, and wherein the particular digits of the plurality of numbers defining the one or more visual characteristics of the 3D model impose a particular relationship among the plurality of numbers, and wherein the identifier code comprises the particular relationship.

20. A method for implementing source identifiers into 3D content, comprising:
accessing one or more numbers defining one or more visual characteristics of a 3D model; and
modifying digits of the one or more numbers defining the one or more visual characteristics of the 3D model to implement an identifier code, the identifier code being associated with a particular source such that subsequent detection of the identifier code within the 3D model or a derivative 3D model derived from the 3D model indicates that the 3D model or the derivative 3D model originated from the particular source.
